(19) United States
(12) Patent Application Publication
(10) Pub. No.: US 2019/0212135 A1
(43) Pub. Date: Jul. 11, 2019

(54) Methods And Systems For 3D Scanning

(71) Applicant: Lenscloud LLC, Brooklyn, NY (US)

(72) Inventors: Brett D. Basler, Kent, WA (US); Ryan Jacob Paxton, New Haven, CT (US)

(21) Appl. No.: 16/241,698

(22) Filed: Jan. 7, 2019

Related U.S. Application Data
(60) Provisional application No. 62/614,836, filed on Jan. 8, 2018.

(51) Int. Cl. G01B 11/25; G06T 17/05; H04N 5/376; G06T 11/00

(52) U.S. Cl. CPC G01B 11/2518; G06T 11/001; H04N 5/3765; G06T 17/05

(57) ABSTRACT

Disclosed are methods and systems for 3D scanning.

### CROSS REFERENCE TO RELATED PATENT APPLICATION

This application claims priority to U.S. Provisional Application No. 62/614,836 filed Jan. 8, 2018, herein incorporated by reference in its entirety.

### SUMMARY

It is to be understood that both the following general description and the following detailed description are exemplary and explanatory only and are not restrictive. Provided are methods and systems for three dimensional (3D) scanning.

Disclosed are methods comprising receiving, at a computing device, a command to initiate a capture process of a three dimensional object via a plurality of towers coupled to the computing device, wherein each of the plurality of towers comprises a set of cameras, a light source, and a projector, synchronizing a plurality of clocks, each clock resident in a camera of the sets of cameras, causing the light sources to emit light onto the three dimensional object, causing the projectors to project a pattern onto the three dimensional object, causing, based on the synchronized clocks, each camera in the sets of cameras to capture an image of the three dimensional object, receiving the images of the three dimensional object, and, processing the images to generate a photogrammetry data structure comprising the images.

Disclosed are methods comprising receiving, at a computing device, a command to initiate a capture process of a three dimensional object via a plurality of towers coupled to the computing device, wherein each of the plurality of towers comprises a set of cameras, a light source, and a projector, synchronizing a plurality of clocks, each clock resident in a camera of the sets of cameras, causing the light sources to emit light onto the three dimensional object, causing, based on the synchronized clocks, each camera in the sets of cameras to capture a texture image of the three dimensional object, causing the projectors to project a pattern onto the three dimensional object, causing, based on the synchronized clocks, each camera in the sets of cameras to capture a projection image of the three dimensional object, receiving the texture images and the projection images of the three dimensional object, and, processing the texture images and the projection images to generate a photogrammetry data structure comprising the texture images and the projection images.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an example system for 3D scanning;

FIG. 2 is an example tower for use in a system for 3D scanning;

FIG. 3 is an example system for 3D scanning;

FIG. 4 is an example user interface for use in a system for 3D scanning;

FIG. 5 is an example method;

FIG. 6 is an example method; and

FIG. 7 is an example system for 3D scanning.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Methods and systems are disclosed for scanning an object. The methods and systems can generate data that can be used for generating a three dimensional representation (e.g., model) of the scanned object. The disclosed methods and systems relate to photogrammetry. Photogrammetry is a technique for determining the shape, the dimensions, and/or the position of an object, on the basis of perspective views of said object recorded using photographic methods.

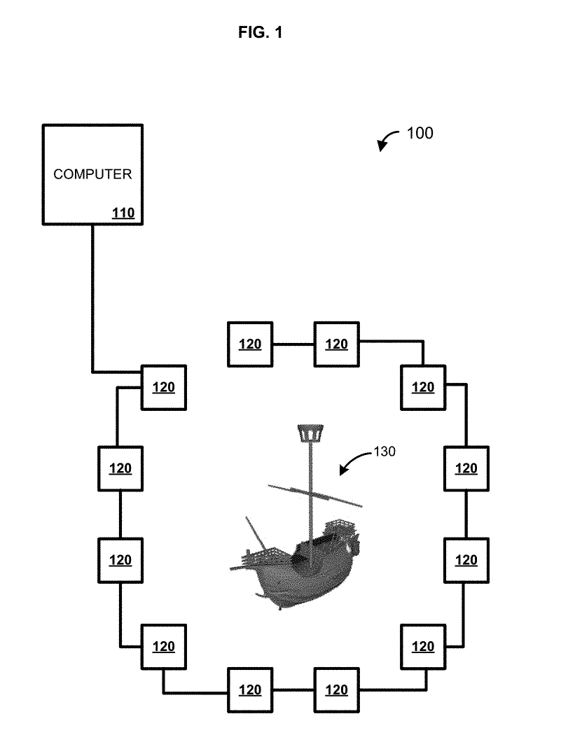

FIG. 1 is a block diagram of a system 100 for determining a 3D model of an object 130. The system 100 can comprise a plurality of towers 120 in communication with a computer 110. The object 130 may be, for example, some or all of a living being such as a human body, a human face, and the like. The object 130 can be a material object of fixed or variable shape. The example object 130 used in FIG. 1 represents a sail boat.

A tower 120 can be a capture device capable of providing an image of at least a portion of a surface of the object 130. The towers 120 can obtain image data representing the scanned object 130 and can provide the image data to the computer 110 and/or store the image data on a medium for subsequent transmission to the computer 110. The image data can comprise one or more frames produced by a camera contained within the towers 120 during the process of scanning. The computer 110 can utilize software to receive/retrieve and process the image data obtained by the towers 120 so as to generate a data structure configured for use in constructing the 3D geometry of the scanned object 130. Any number of towers 120 can be used to obtain image data of the object 130. The more towers 120 that are implemented, the higher the resolution of a 3D model that can ultimately be generated. The towers 120 can be positioned around the object 130 to permit adequate overlap of images for triangulation of points in a photogrammetry process while maintaining high enough resolution (e.g., 30-40 inches from the object 130).

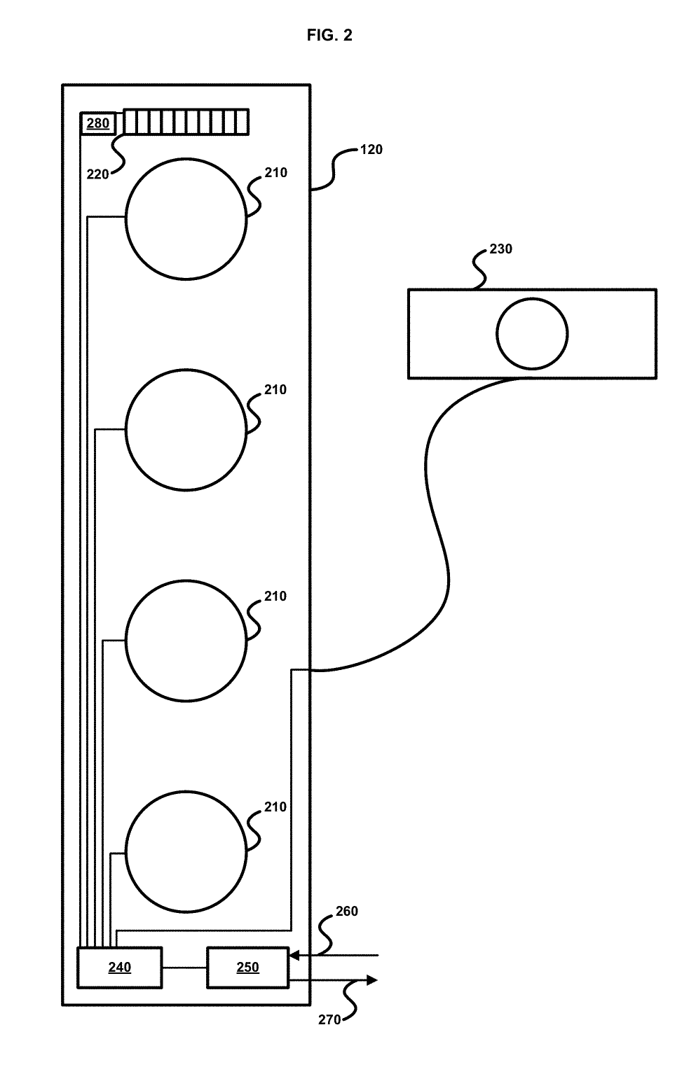

The towers 120, illustrated in FIG. 2, can comprise one or more cameras 210 (e.g. camera sensors), a light source 220, a projector 230, a microcomputer 240, and/or a network device 250. The one or more cameras 210 can comprise conventional cameras (e.g., DSLR) configured for capturing one or more images. For example, one or more SONY IMX219 image sensors can be used (8 megapixel fixed focal length board mount camera). The one or more cameras 210 can be configured for storing the images on a storage device such as a computer readable medium (e.g., onboard memory, removable memory cards, etc. . . . ). Any number of cameras 210 can be integrated into the towers 120. Each camera 210 can be assigned a unique identifier. The unique identifier can identity which tower the camera is in and what position the camera is in the tower. For example, a unique identifier of “x003x004” can identify a camera as contained within tower 3 in position 4. Each of the one or more cameras 210 can comprise a clock. The clock can be used to coordinate capture of image data by the one or more cameras 210. The one or more cameras 210 can be configured to run client software that can communicate with server software run by the computer 110. The client software can receive commands from the server software to cause the one or more cameras 210 to power on/power off, capture image data, delete image data, synchronize the clocks, indicate that image data is available for retrieval by the server software, and the like. Each one or more cameras 210 can be connected to a microcomputer 240 (e.g., via a CSI cable). Each microcomputer 240 can comprise a processor, memory, a wireless transceiver, and/or an on-board Ethernet port. The on-board Ethernet port can be connected to a network device 250 (e.g., a Gigabit switch or other router/switch). Network device 250 can be configured to have one or more incoming connections 260 and one or more outgoing connections 270 to allow for a daisy chain of towers 120. Any one tower 120 can then be connected to the computer 110 which communicates with the towers 120 (e.g., array of towers, network of microcomputers/cameras).

The light source 220 can comprise an LED, a laser, a halogen bulb, and the like. The light source 220 can be configured for illuminating at least a portion of the object 130. Each light source 220 can be contained within a tower 120 and can be connected to the microcomputer 240 within said tower 120. A signal can be sent from the computer 110 to the microcomputer 240 within each tower 120 over a network connection. That microcomputer 240 sends a signal (e.g., via General-purpose input/output (GPIO)) to a relay 280 that turns the light source 220 on or off. In an aspect, a lighting control board (not shown) can be used to enable control of the intensity of the light source 220 based on a voltage applied.

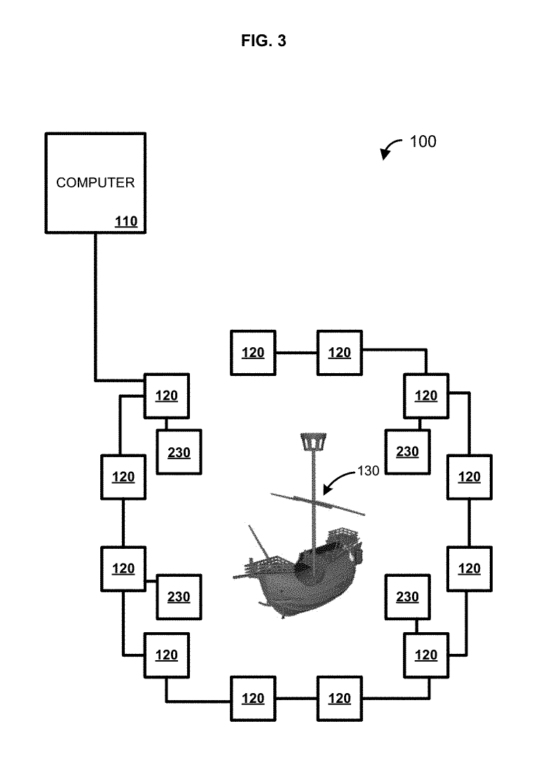

The projector 230 can be, for example, a DLP projector, an LCD projector, an LED projector, and the like. The projector 230 can be configured for projecting a pattern onto at least a portion of the object 130. The pattern can be, for example, a black and white pattern. The pattern can be, for example, a series of lines, a checkerboard pattern, and the like. In an aspect, the projector 230 can be integrated into the tower 120 or physically separate from the tower 120 (e.g., connected via an input/output port such as HDMI). A signal can be sent from the computer 110 to the microcomputer 240 within each tower 120 over a network connection. That microcomputer 240 can send a signal via the on-board HDMI port. An “on/off” function can be configured to toggle between a digital noise pattern (on) and a black image (off). FIG. 3 illustrates an example system with physically separate projectors 230.

The angles between directions of the one or more cameras 210 and the light source 220 can be adjustable to ensure that the at least a portion of the object 130, illuminated by the light source 220, is within a viewing area of the one or more cameras 210. In an aspect, the one or more cameras 210 and the light source 220 can be mounted such that they move together. For example, the one or more cameras 210 and the light source 220 can be supported by a physical support structure that allows movement in the pan/tilt directions but restricts the movement in the swivel direction. Thus, the one or more cameras 210 and the light source 220 are permitted to move up and down or left and right in one plane. In addition, motorized pan/tilt heads can be used to remotely control the movement of the one or more cameras 210 and the light source 220.

The computer 110 can be configured to run server software that can communicate with the client software resident on each of the one or more cameras 210. The computer 110 can be configured to provide a user interface to enable a user to control one or more functions of the system 100. The computer 110 can provide a user with the ability to initiate a capture process to obtain image data from the one or more cameras 210. The computer 110 can process the image data to generate a photogrammetry data structure. The computer 110 can further process the photogrammetry data structure to generate a 3D representation of the scanned object 130. The computer 110 can also provide the photogrammetry data structure to another computing device for generation of a 3D representation of the scanned object 130.

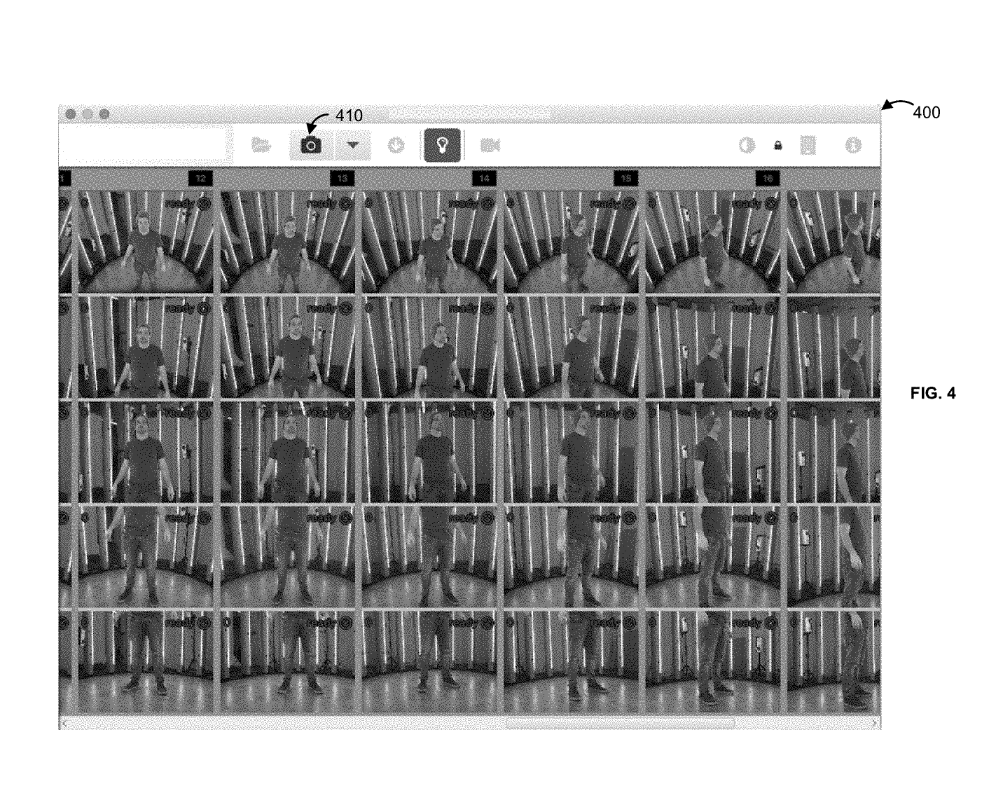

FIG. 4 illustrates an example user interface 400. The user interface 400 shows image output from each camera of each tower arranged by column. Tower 12, tower 13, tower 14, tower 15, and tower 16 are shown in user interface 400. The top row of images represents images from cameras in the highest vertical position in each respective tower. Each row below the top row represents images from the successive cameras below the camera in the highest vertical position. A user can drag the interface left or right to show image output from other towers. To initiate a scan of a 3D object, a user can engage user interface element 410.

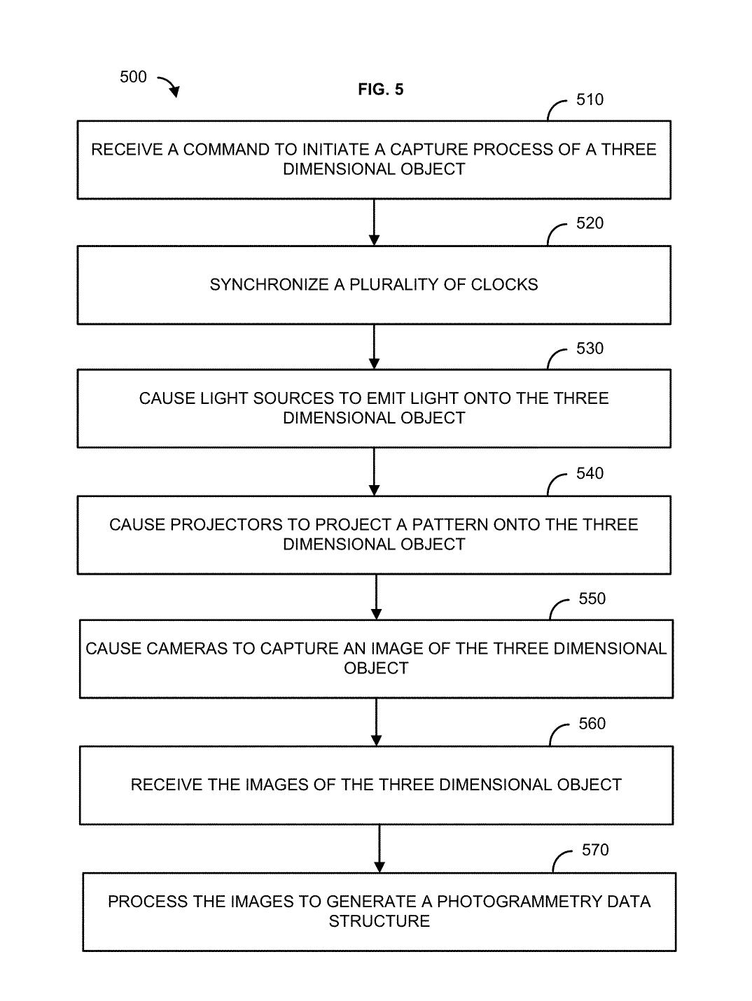

In operation, the computer 110 can initiate a single-capture process or a multi-capture process. As shown in FIG. 5, at step 510, a single-capture process 500 can comprise receiving, at the computer 110, a command to initiate a single-capture process 500 of a three dimensional object 130 via a plurality of towers 120 coupled to the computer 110, wherein each of the plurality of towers 120 comprises a set of cameras 210, a light source 220, and a projector 230. The single-capture process 500 can further comprise adjusting a position of at least one camera of the sets of cameras. Adjusting a position of at least one camera of the sets of cameras can comprise causing a motor attached to the at least one camera to adjust the position. Each camera of the sets of cameras can comprise a unique identifier associated with a position of the camera in the respective tower.

At step 520, the single-capture process 500 can synchronize a plurality of clocks, each clock resident in a camera of the sets of cameras. Synchronizing the plurality of clocks can comprise retrieving a current time from one clock of the plurality of clocks and setting all clocks of the plurality of clocks to the current time.

At step 530, the single-capture process 500 can cause the light sources to emit light onto the three dimensional object.

At step 540, the single-capture process 500 can cause the projectors to project a pattern onto the three dimensional object. The pattern can comprise a pattern of alternating black and white noise pattern.

At step 550, the single-capture process 500 can cause, based on the synchronized clocks, each camera in the sets of cameras to capture an image of the three dimensional object. Causing, based on the synchronized clocks, each camera in the sets of cameras to capture an image of the three dimensional object can comprise adding a time interval to the current time and instructing the plurality of cameras to capture the image once the time interval is reached. In an aspect, the single-capture process 500 can cause adjustment to shutter speed of each camera before image capture. Each camera can timestamp the image captured. Each camera can append its unique identifier to the timestamp, or otherwise associate the unique identifier with the image. Each camera can store its image, along with the timestamp and/or unique identifier in temporary memory or long term memory. Each camera can provide an indication to the computer that an image is available for transmission to/retrieval by the computer.

At step 560, the single-capture process 500 can receive the images of the three dimensional object. Receiving the images of the three dimensional object can comprise receiving an indication from each camera of the sets of cameras that an image is available. Receiving the images of the three dimensional object can comprise receiving a respective unique identifier associated with a respective image and/or a timestamp associated with the time the respective image was captured. In an aspect, the computer can receive/retrieve the images based on the timestamp (e.g., oldest image first, newest image first, etc. . . . ). The images of the three dimensional object can be received/retrieved wirelessly or over a wired connection (e.g., 10/100 mb Ethernet via UDP).

At step 570, the single-capture process 500 can process the images to generate a photogrammetry data structure comprising the images. The photogrammetry data structure can comprise a photo stack.

The single-capture process 500 can further comprise processing the photogrammetry data structure to generate a three dimensional image of the three dimensional object.

The single-capture process 500 can further comprise providing an interface configured for viewing the images. The single-capture process 500 can further comprise determining that at least one image is unsuitable for generating a three dimensional image.

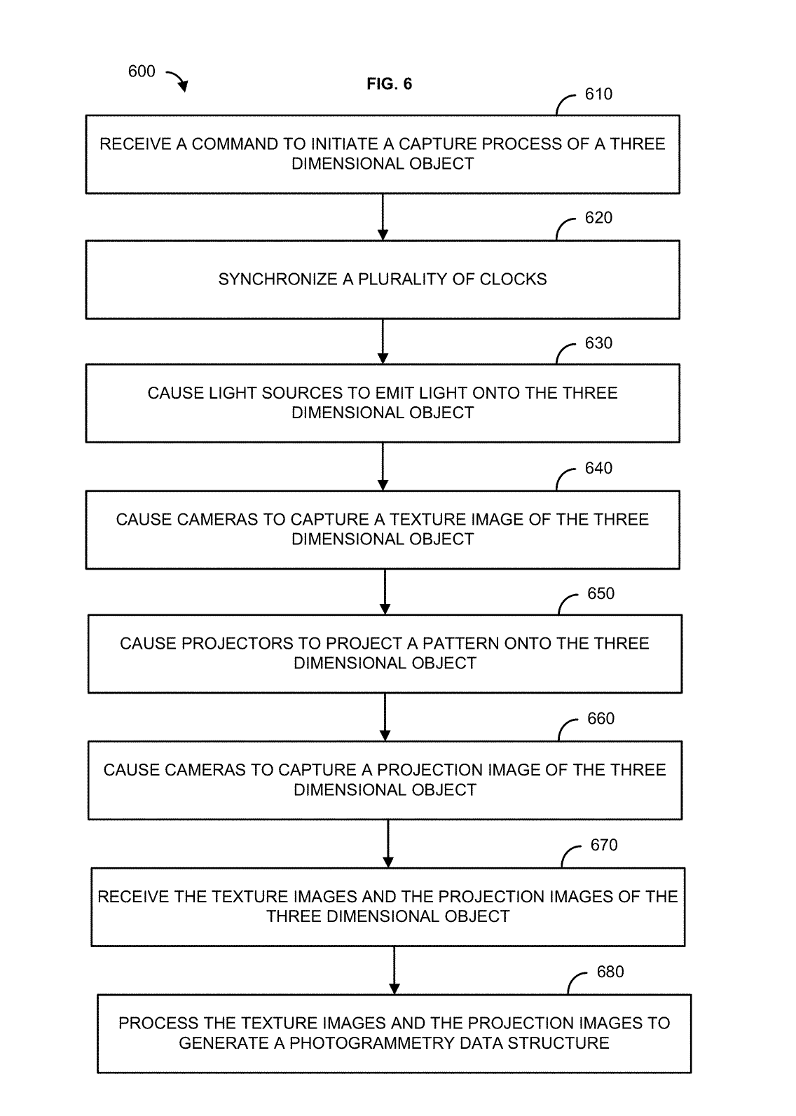

As shown in FIG. 6, at step 610, a multi-capture process 600 can comprise receiving, at a computing device, a command to initiate a multi-capture process 600 of a three dimensional object 130 via a plurality of towers 120 coupled to the computer 110, wherein each of the plurality of towers 120 comprises a set of cameras 210, a light source 220, and a projector 230. The multi-capture process 600 can further comprise adjusting a position of at least one camera of the sets of cameras. Adjusting a position of at least one camera of the sets of cameras can comprise causing a motor attached to the at least one camera to adjust the position. Each camera of the sets of cameras can comprise a unique identifier associated with a position of the camera in the respective tower.

At step 620, the multi-capture process 600 can synchronize a plurality of clocks, each clock resident in a camera of the sets of cameras. Synchronizing the plurality of clocks can comprise retrieving a current time from one clock of the plurality of clocks and setting all clocks of the plurality of clocks to the current time.

At step 630, the multi-capture process 600 can cause the light sources to emit light onto the three dimensional object.

At step 640, the multi-capture process 600 can cause, based on the synchronized clocks, each camera in the sets of cameras to capture a texture image of the three dimensional object. Each camera can timestamp the texture image captured. Each camera can append its unique identifier to the timestamp, or otherwise associate the unique identifier with the texture image. Each camera can store its texture image, along with the timestamp and/or unique identifier in temporary memory or long term memory. Each camera can provide an indication to the computer that a texture image is available for transmission to/retrieval by the computer.

At step 650, the multi-capture process 600 can cause the projectors to project a pattern onto the three dimensional object.

At step 660, the multi-capture process 600 can cause, based on the synchronized clocks, each camera in the sets of cameras to capture a projection image of the three dimensional object. Each camera can timestamp the projection image captured. Each camera can append its unique identifier to the timestamp, or otherwise associate the unique identifier with the projection image. Each camera can store its projection image, along with the timestamp and/or unique identifier in temporary memory or long term memory. Each camera can provide an indication to the computer that a projection image is available for transmission to/retrieval by the computer.

At step 670, the multi-capture process 600 can receive the texture images and the projection images of the three dimensional object. Receiving the texture images and the projection images of the three dimensional object can comprise receiving a respective unique identifier associated with a respective texture and/or projection image and/or a timestamp associated with the time the respective texture and/or projection image was captured. In an aspect, the computer can receive/retrieve the texture images and the projection images based on the timestamp (e.g., oldest image first, newest image first, etc. . . . ). The texture images and the projection images of the three dimensional object can be received/retrieved wirelessly or over a wired connection (e.g., 10/100 mb Ethernet via UDP).

At step 680, the multi-capture process 600 can process the texture images and the projection images to generate a photogrammetry data structure comprising the texture images and the projection images. The photogrammetry data structure can comprise a photo stack.

The multi-capture process 600 can further comprise processing the photogrammetry data structure to generate a three dimensional image of the three dimensional object.

The multi-capture process 600 can further comprise providing an interface configured for viewing the images. The multi-capture process 600 can further comprise determining that at least one image is unsuitable for generating a three dimensional image.

In an aspect, the system 100 can implement a dual camera system implementing infrared technology (e.g., one or more infrared projectors configured to project an infrared laser pattern onto the object). In an aspect, two cameras can be in each position of a tower 120 instead of a single camera. One camera can be configured to capture an infrared image (projection image) and the other camera can be configured to capture a visible light image (texture image). For example, at step 630 when the light source emits light onto the three dimensional object, the infrared projectors can simultaneously emit infrared light (e.g., a pattern) on the three dimensional object (e.g., infrared dot projection). Thus, the two cameras can each capture an image simultaneously (the projection image and the texture image) relying on infrared projection and light.

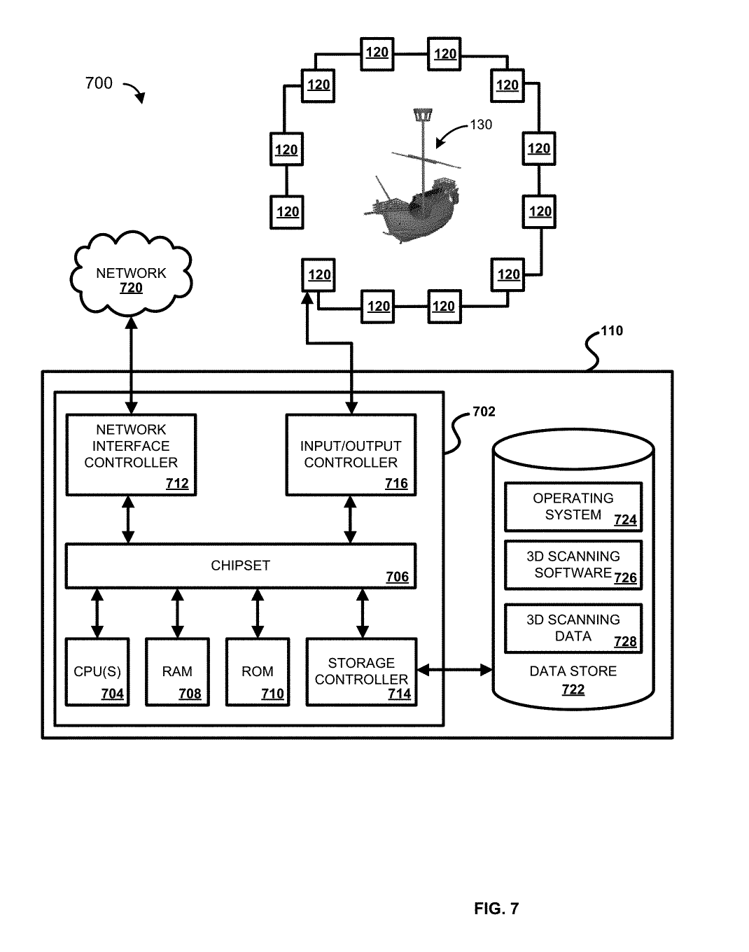

In an exemplary aspect, the methods and systems can be implemented on the computer 110 as illustrated in FIG. 7 and described below. The methods and systems disclosed can utilize one or more computers 110 to perform one or more functions in one or more locations. FIG. 7 is a block diagram illustrating an exemplary operating environment 700 for performing the disclosed methods. This exemplary operating environment 700 is only an example of an operating environment and is not intended to suggest any limitation as to the scope of use or functionality of operating environment architecture. Neither should the operating environment 700 be interpreted as having any dependency or requirement relating to any one or combination of components illustrated in the exemplary operating environment 700.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media including memory storage devices. For example, the systems and methods disclosed herein can be implemented via a computing device in the form of the computer 110.

FIG. 7 shows an example computer architecture for the computer 110. The computer 110 can be configured for executing program components for conducting 3-D scanning in the manner described above. The computer architecture shown in FIG. 7 illustrates a server computer, workstation, desktop computer, laptop, tablet, network appliance, personal digital assistant (“PDA”), e-reader, digital cellular phone (smartphone), or other computing device, and may be utilized to execute any of the software components presented herein. For example, the computer architecture shown in FIG. 7 may be utilized to execute software components for performing operations as described above.

The computer 110 includes a baseboard 702, or “motherboard,” which is a printed circuit board to which a multitude of components or devices may be connected by way of a system bus or other electrical communication paths. In one illustrative example, one or more central processing units (“CPUs”) 704 operate in conjunction with a chipset 706. The CPUs 704 may be standard programmable processors that perform arithmetic and logical operations necessary for the operation of the computer 110.

The CPUs 704 perform operations by transitioning from one discrete, physical state to the next through the manipulation of switching elements that differentiate between and change these states. Switching elements may generally include electronic circuits that maintain one of two binary states, such as flip-flops and electronic circuits that provide an output state based on the logical combination of the states of one or more other switching elements, such as logic gates. These basic switching elements may be combined to create more complex logic circuits, including registers, adders-subtractors, arithmetic logic units, floating-point units and the like. In the case of multiple CPUs 704, the computer 110 can utilize parallel computing.

The chipset 706 provides an interface between the CPUs 704 and the remainder of the components and devices on the baseboard 702. The chipset 706 may provide an interface to a RAM 708, used as the main memory in the computer 110. The chipset 706 may further provide an interface to a computer-readable storage medium such as a read-only memory (“ROM”) 710 or non-volatile RAM (“NVRAM”) for storing basic routines that help to startup the computer 110 and to transfer information between the various components and devices. The ROM 710 or NVRAM may also store other software components necessary for the operation of the computer 110 in accordance with the examples described herein.

The computer 110 may operate in a networked environment using logical connections to remote computing devices and computer systems through a network, such as a network 720. The network 720 can comprise the Internet and/or a local area network. Other forms of communications can be used such as wired and wireless telecommunication channels, for example. The chipset 706 may include functionality for providing network connectivity through a network interface controller (“NIC”) 712, such as a gigabit Ethernet adapter. The NIC 712 is capable of connecting the computer 110 to other computing devices over the network 720. It should be appreciated that multiple NICs 712 may be present in the computer 110, connecting the computer to other types of networks and remote computer systems.

The computer 110 may be connected to a data store, such as the data store 722, that provides non-volatile storage for the computer 110. The data store 722 may store system programs, application programs, other program modules and data, which have been described in greater detail herein. The data store 722 may be connected to the computer 110 through a storage controller 714 connected to the chipset 706. The data store 722 may comprise one or more physical storage units. The storage controller 714 may interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 110 may store data on the data store 722 by transforming the physical state of the physical storage units to reflect the information being stored. The specific transformation of physical state may depend on various factors, in different implementations of this description. Examples of such factors may include, but are not limited to, the technology used to implement the physical storage units, whether the data store 722 is characterized as primary or secondary storage and the like.

For example, the computer 110 may store information to the data store 722 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 110 may further read information from the data store 722 by detecting the physical states or characteristics of one or more particular locations within the physical storage units.

In addition to the data store 722 described above, the computer 110 may have access to other computer-readable storage media to store and retrieve information, such as program modules, data structures, or other data. It should be appreciated by those skilled in the art that computer-readable storage media is any available media that provides for the non-transitory storage of data and that may be accessed by the computer 110.

By way of example, and not limitation, computer-readable storage media may include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

The data store 722 may store an operating system 724 utilized to control the operation of the computer 110. According to one example, the operating system 724 comprises the LINUX operating system. According to another example, the operating system comprises a WINDOWS® operating system from MICROSOFT Corporation. According to further examples, the operating system may comprise the UNIX operating system or the ANDROID operating system. It should be appreciated that other operating systems may also be utilized. The data store 722 may store other system or application programs and data utilized by the computer 110, such as components that include 3D scanning software 726, 3D scanning data 728, and/or any other software components and data described above. The data store 722 can also store other programs and data not specifically identified herein.

In one example, the data store 722 or other computer-readable storage media is encoded with computer-executable instructions which, when loaded into the computer 110, transform the computer from a general-purpose computing system into a special-purpose computer capable of implementing the examples described herein. These computer-executable instructions transform the computer 110 by specifying how the CPUs 704 transition between states, as described above. According to one example, the computer 110 has access to computer-readable storage media storing computer-executable instructions which, when executed by the computer 110, perform the various routines described above. The computer 110 can also include computer-readable storage media for performing any of the other computer-implemented operations described herein.

The computer 110 may also include one or more input/output controllers 716 for receiving and processing input from a number of input devices, such as a keyboard, a mouse, a touchpad, a touch screen, an electronic stylus, or other type of input device. Similarly, the input/output controller 716 may provide output to a display, such as a computer monitor, a flat-panel display, a digital projector, a printer, a plotter, or other type of output device. One or more towers 120 can be in communication with the input/output controller 716. For example, via a wired and/or wireless connection. The input/output controller 716 can transmit and/or receive data and/or instructions to and/or from the one or more towers 120. It will be appreciated that the computer 110 may not include all of the components shown in FIG. 7, may include other components that are not explicitly shown in FIG. 7, or may utilize an architecture completely different than that shown in FIG. 7.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
receiving, at a computing device, a command to initiate a capture process of a three dimensional object via a plurality of towers coupled to the computing device, wherein each of the plurality of towers comprises a set of cameras, a light source, and a projector;
synchronizing a plurality of clocks, each clock resident in a camera of the sets of cameras;
causing the light sources to emit light onto the three dimensional object;
causing the projectors to project a pattern onto the three dimensional object;
causing, based on the synchronized clocks, each camera in the sets of cameras to capture an image of the three dimensional object;
receiving the images of the three dimensional object; and
processing the images to generate a photogrammetry data structure comprising the images.

2. The method of claim 1, wherein each camera of the sets of cameras comprises a unique identifier associated with a position of the camera in the respective tower.

3. The method of claim 2, wherein receiving the images of the three dimensional object comprises receiving a respective unique identifier associated with a respective image.

4. The method of claim 1, wherein synchronizing a plurality of clocks, each clock resident in a camera of the sets of cameras comprises:
retrieving a current time from one clock of the plurality of clocks; and
setting all clocks of the plurality of clocks to the current time.

5. The method of claim 4, wherein causing, based on the synchronized clocks, each camera in the sets of cameras to capture an image of the three dimensional object comprises:
adding a time interval to the current time; and
instructing the plurality of cameras to capture the image once the time interval is reached.

6. The method of claim 1, wherein the pattern comprises a pattern of alternating black and white noise pattern.

7. The method of claim 1, wherein receiving the images of the three dimensional object comprises receiving an indication from each camera of the sets of cameras that an image is available.

8. The method of claim 1, wherein the photogrammetry data structure comprises a photo stack.

9. The method of claim 1, further comprising processing the photogrammetry data structure to generate a three dimensional image of the three dimensional object.

10. The method of claim 1, further comprising adjusting a position of at least one camera of the sets of cameras.

11. The method of claim 10, wherein adjusting a position of at least one camera of the sets of cameras comprises causing a motor attached to the at least one camera to adjust the position.

12. The method of claim 1, further comprising providing an interface configured for viewing the images.

13. The method of claim 1, further comprising determining that at least one image is unsuitable for generating a three dimensional image.

14. A method comprising:
receiving, at a computing device, a command to initiate a capture process of a three dimensional object via a plurality of towers coupled to the computing device, wherein each of the plurality of towers comprises a set of cameras, a light source, and a projector;
synchronizing a plurality of clocks, each clock resident in a camera of the sets of cameras;
causing the light sources to emit light onto the three dimensional object;
causing, based on the synchronized clocks, each camera in the sets of cameras to capture a texture image of the three dimensional object;
causing the projectors to project a pattern onto the three dimensional object;
causing, based on the synchronized clocks, each camera in the sets of cameras to capture a projection image of the three dimensional object;
receiving the texture images and the projection images of the three dimensional object; and
processing the texture images and the projection images to generate a photogrammetry data structure comprising the texture images and the projection images.

15. The method of claim 14, wherein each camera of the sets of cameras comprises a unique identifier associated with a position of the camera in the respective tower.

16. The method of claim 15, wherein receiving the texture images and the projection images of the three dimensional object comprises receiving a respective unique identifier associated with a respective texture image or a respective projection image.

17. The method of claim 14, wherein synchronizing a plurality of clocks, each clock resident in a camera of the sets of cameras comprises:
retrieving a current time from one clock of the plurality of clocks; and
setting all clocks of the plurality of clocks to the current time.

18. The method of claim 17, wherein causing, based on the synchronized clocks, each camera in the sets of cameras to capture an image of the three dimensional object comprises:
adding a time interval to the current time; and
instructing the plurality of cameras to capture the image once the time interval is reached.

19. The method of claim 14, wherein the pattern comprises a pattern of alternating black and white noise pattern.

20. The method of claim 14, wherein receiving the texture images and the projection images of the three dimensional object comprises receiving an indication from each camera of the sets of cameras that a texture image or a projection image is available.
